(19) United States
(12) Patent Application Publication
(10) Pub. No.: US 2012/0319990 A1
(43) Pub. Date: Dec. 20, 2012

(54) TOUCH DISPLAY DEVICE

(76) Inventors: Chien-Ting CHAN, Tainan (TW); Yi-Chung Juan, Tainan (TW); Kuo-Sheng Lee, Tainan (TW); Chang-Ching Yeh, Penghu (TW); Sung-Chun Lin, Tainan (TW)

(21) Appl. No.: 13/305,221

(22) Filed: Nov. 28, 2011

(30) Foreign Application Priority Data
Jun. 14, 2011 (TW) 100120649

(51) Int. Cl. G06F 3/045

(52) U.S. Cl. 345/174

(57) ABSTRACT

A touch display device is provided. The touch display device includes a touch panel disposed on a display panel. The touch panel includes a plurality of first conductive patterns arranged along a first direction, wherein the first conductive patterns are separated from each other. A plurality of second conductive patterns is arranged along a second direction perpendicular to the first direction, wherein the second conductive patterns are connected with each other. An isolation structure is disposed between any two adjacent first conductive patterns. A plurality of conductive bridge structures is disposed on the isolation structure for electrically connecting any two adjacent first conductive patterns.

### CROSS REFERENCE TO RELATED APPLICATIONS

This Application claims priority of Taiwan Patent Application No. 100120649, filed on Jun. 14, 2011, the entirety of which is incorporated by reference herein.

### BACKGROUND OF THE INVENTION

1. Field of the Invention

The present invention relates to a touch display device, and in particular relates to a touch sensor structure design for a capacitive touch panel.

2. Description of the Related Art

Currently, there are two types of capacitive touch panels. One type of capacitive touch panel is an add-on touch panel. The add-on touch panel is disposed on the outside of a display panel. The add-on touch panel is formed from two glass substrates. One glass substrate is used for forming capacitive touch sensors thereon. Another glass substrate is used as a cover lens for protecting the capacitive touch sensors. Another type of capacitive touch panel is an on-glass typed touch panel. The on-glass typed touch panel has capacitive touch sensors formed on a cover lens thereof and then the on-glass typed touch panel is bonded with a display panel.

Both the add-on capacitive touch panels and the on-glass typed capacitive touch panels have a bridge structure for electrically connecting the touch sensors. The conventional bridge structure is generally an island-typed bridge structure or a via-typed bridge structure. The two types of conventional bridge structures are formed from a metal material, thus the conventional touch panels have a serious light reflection problem and cause the display image quality of the conventional touch display devices to be poor. Also, the conventional bridge structures have a high resistance, thus the conventional touch panels have poor touch sensitivity.

### BRIEF SUMMARY OF THE INVENTION

According to an illustrative embodiment, a touch display device is provided. The touch display device includes a touch panel having a touch sensor structure design to overcome the above mentioned problems of the conventional touch panels. Thus, the light reflection problem of the bridge structures formed from metal is overcome and the resistance of the bridge structures is reduced to enhance fabrication yield of the touch displays.

According to an illustrative embodiment, a touch display device is provided. The touch display device comprises a display panel and a touch panel disposed on the display panel. The touch panel comprises a plurality of first conductive patterns arranged along a first direction, wherein the first conductive patterns are separated from each other. A plurality of second conductive patterns is arranged along a second direction perpendicular to the first direction, wherein the second conductive patterns are connected with each other. An isolation structure is disposed between any two adjacent first conductive patterns. A plurality of conductive bridge structures is disposed on the isolation structure for electrically connecting the any two adjacent first conductive patterns.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows an illustrative top view of a portion of a touch panel according to an embodiment of the invention;

FIG. 2 shows an illustrative top view of a portion of a touch panel according to another embodiment of the invention;

FIG. 3 shows an illustrative cross section of a touch display device along the cross section line 3-3′ of FIG. 1 according to an embodiment of the invention;

FIG. 4 shows an illustrative cross section of a touch display device along the cross section line 4-4′ of FIG. 1 according to an embodiment of the invention;

FIG. 5 shows an illustrative cross section of a touch display device along the cross section line 5-5′ of FIG. 2 according to an embodiment of the invention; and

FIG. 6 shows an illustrative cross section of a touch display device along the cross section line 6-6′ of FIG. 2 according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In embodiments of the invention, touch display devices are provided. The touch display device includes a touch panel disposed on a display panel. The touch panel includes a plurality of capacitive touch sensors. The capacitive touch sensors include a plurality of first conductive patterns arranged into a plurality of columns and a plurality of second conductive patterns arranged into a plurality of rows. The first and second conductive patterns are disposed in the same layer. In order to prevent the crossings of the first and second conductive patterns from shorting, in an embodiment, the first conductive patterns arranged into a column are separated from each other. Then, any two adjacent first conductive patterns are electrically connected by a plurality of conductive bridge structures. Moreover, an isolation structure is disposed between the conductive bridge structures and a connection portion of any two adjacent second conductive patterns for electrically isolating the conductive bridge structures and the second conductive patterns.

According to the embodiments of the invention, the conductive bridge structures have a line width which is not observed by human eyes. In an embodiment, the line width of the conductive bridge structures is about 4 μm to about 10 μm. Thus, the light reflection problem of the conventional bridge structures formed from metal is overcome. Meanwhile, in order to reduce the resistance of the conductive bridge structures, according to the embodiments of the invention, two or more than two conductive bridge structures are used to electrically connect any two adjacent first conductive patterns. Moreover, two or more than two conductive bridge structures are used to enhance the fabrication yield of the touch panels.

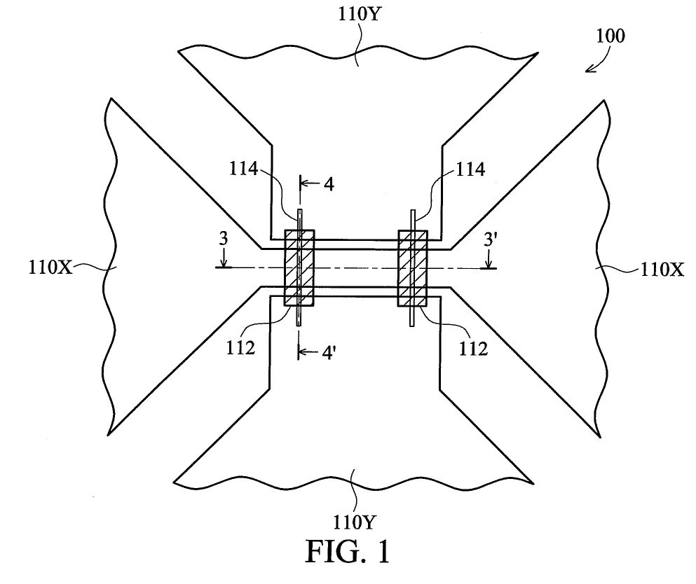

Referring to FIG. 1, a partial top view of a touch panel 100 according to an embodiment of the invention is shown. The touch panel 100 is for example a touch panel with capacitive touch sensors. The capacitive touch sensors include a plurality of first conductive patterns 110Y arranged into a plurality of columns The first conductive patterns 110Y in a column are separated from each other. The capacitive touch sensors further include a plurality of second conductive patterns 110X arranged into a plurality of rows. The second conductive patterns 110X in a row are connected with each other. Although the complete first conductive patterns 110Y and the complete second conductive patterns 110X are not shown in FIG. 1, one skilled in the art should appreciate that the first conductive patterns 110Y and the second conductive patterns 110X may be a rhombus-shaped or other shaped conductive pattern.

As shown in FIG. 1, two conductive bridge structures 114 are used for electrically connecting two adjacent first conductive patterns 110Y. An isolation structure 112 is disposed under the conductive bridge structure 114 for electrically isolating the conductive bridge structure 114 and the connection portion of the second conductive patterns 110X. Thus, shorting does not occur between the first conductive patterns 110Y and the second conductive patterns 110X.

In one type of conventional touch panel as known by the inventors, only one metal bridge is used to electrically connect two adjacent first conductive patterns and the metal bridge used in the conventional touch panels has a line width of above 10 μm. Thus, the metal bridge used in the conventional touch panels causes a light reflection problem and reduces display quality of the conventional touch display devices.

In an embodiment, the material of the conductive bridge structures 114 may be a metal material and the line width of the conductive bridge structures 114 is about 5 μm. Therefore, the conductive bridge structures 114 in the touch panels 100 are not observed by human eyes and it prevents the light reflection problem occurring in the touch panels 100. Meanwhile, two or more than two conductive bridge structures 114 are used in the embodiments of the invention. Although the line width of the conductive bridge structures 114 in the touch panels 100 of the embodiments is decreased to about 5 μm, the resistances obtained from the plurality of conductive bridge structures 114 is equal to or lower than the resistance of the conventional metal bridge in the conventional touch panels. Also, when one conductive bridge structure 114 in the touch panels 100 of the embodiments is broken, the other conductive bridge structure 114 can be used to electrically connect two adjacent first conductive patterns 110Y. Thus, the design of the conductive bridge structures 114 of the embodiments can enhance fabrication yield of the touch panel 100.

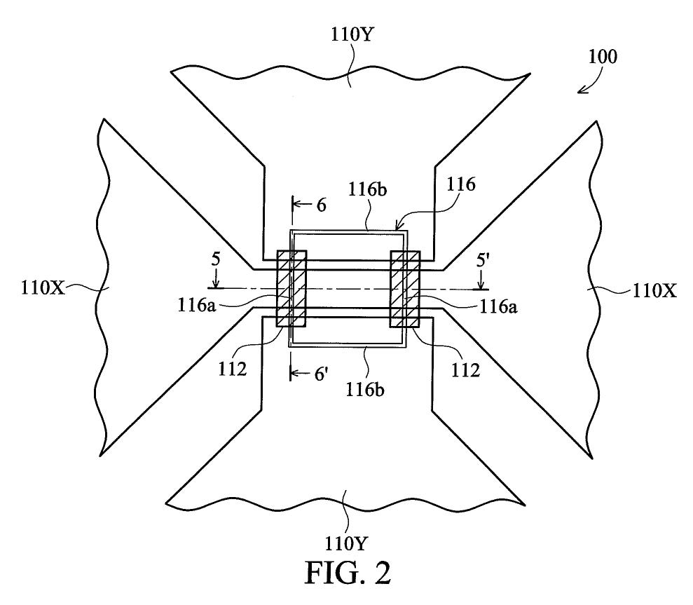

Referring to FIG. 2, a partial top view of a touch panel 100 according to another embodiment of the invention is shown. The difference between the touch panel 100 of FIG. 2 and the touch panel 100 of FIG. 1 is that the touch panel 100 of FIG. 2 has two vertical conductive bridge structures 116a and two horizontal conductive strips 116b connecting with the two vertical conductive bridge structures 116a to form a conductive loop 116. The conductive loop 116 electrically connects any two adjacent first conductive patterns 110Y. In an embodiment, the vertical conductive bridge structures 116a and the horizontal conductive strips 116b may be formed from a metal material and have a line width smaller than about 5 μm. Thus, the light reflection problem of the conventional metal bridge is prevented. Moreover, the conductive loop 116 has additional horizontal conductive strips 116b, such that the resistance of the conductive loop 116 is reduced and fabrication yield of the touch panel 100 is enhanced.

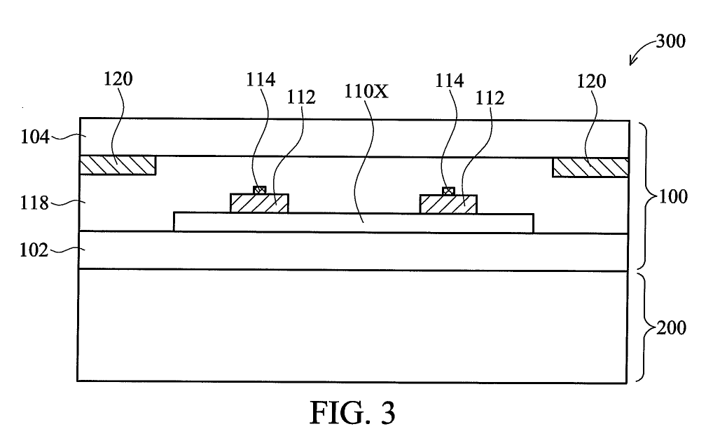

Referring to FIG. 3, a cross section of a touch display device 300 along the cross section line 3-3′ of FIG. 1 according to an embodiment of the invention is shown. The touch display device 300 includes the touch panel 100 disposed on a display panel 200. The display panel 200 may be a liquid crystal display panel or a display panel containing other types of display elements. In an embodiment, the touch panel 100 may be an add-on touch panel, which includes a substrate 102, for example a glass substrate or a flexible plastic substrate. The first conductive patterns 110Y (not shown) and the second conductive patterns 110X are formed on the substrate 102. The materials of the first conductive patterns 110Y (not shown) and the second conductive patterns 110X may be a transparent conductive material, for example indium tin oxide (ITO). The first conductive patterns 110Y (not shown) and the second conductive patterns 110X can be formed by a deposition, a photolithography and an etching process.

The isolation structure 112 is formed on the connection portion of the second conductive patterns 110X. The isolation structure 112 may include one or more than one island. The isolation structure 112 is disposed corresponding to the location of the subsequently formed conductive bridge structure 114. The material of the isolation structure 112 may be an insulating photosensitive material, for example a photoresist. The isolation structure 112 can be formed by a photolithography process.

Then, the conductive bridge structure 114 is formed on the isolation structure 112. The material of the conductive bridge structure 114 may be a transparent conductive material or a metal material, wherein the metal material is preferred. The conductive bridge structure 114 can be formed by a deposition, a photolithography and an etching process.

Next, a protective layer 118 is blanketly formed over the substrate 102 to cover the conductive bridge structure 114, the isolation structure 112, the first conductive patterns 110Y and the second conductive patterns 110X. The material of the protective layer 118 may be an organic or an inorganic insulating material. The inorganic insulating material is for example silicon oxides or silicon nitrides. The organic insulating material is for example an acrylic based photoresist. Then, another substrate 104 is provided to cover the protective layer 118 to form the touch panel 100. The peripheral area of the substrate 104 has a light shielding layer 120 formed thereon. The material of the light shielding layer 120 is for example a black photoresist. The substrate 104 may be a glass substrate or a flexible plastic substrate, which is used as a cover lens of the touch panel 100 to prevent the touch panel 100 from being scratched. Next, the substrate 102 of the touch panel 100 is bonded with the display panel 200 to complete the touch display device 300. When the touch display device 300 is operated by user, a finger of user or a touch pen touches the outside surface of the substrate 104.

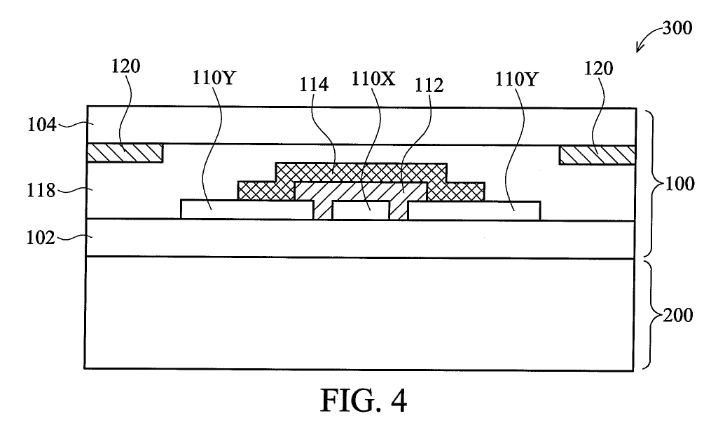

Referring to FIG. 4, a cross section of a touch display device 300 along the cross section line 4-4′ of FIG. 1 according to an embodiment of the invention is shown. The touch display device 300 of FIG. 4 includes the touch panel 100 disposed on a display panel 200. In an embodiment, the touch panel 100 of FIG. 4 may be an add-on touch panel, which is the same as the touch panel 100 of FIG. 3. The touch panel 100 includes a substrate 102. The first conductive patterns 110Y and the second conductive patterns 110X are formed on the substrate 102. The isolation structure 112 is disposed on the connection portion of the second conductive patterns 110X and a portion of the isolation structure 112 is extended onto the first conductive patterns 110Y. The conductive bridge structure 114 is formed on the isolation structure 112 and extended onto the first conductive patterns 110Y for electrically connecting any two adjacent first conductive patterns 110Y together. The protective layer 118 is blanketly formed over the substrate 102 to protect all elements on the substrate 102. The substrate 104 is used as a cover lens of the touch panel 100. The peripheral area of the substrate 104 has a light shielding layer 120 formed thereon. The substrate 104 is disposed opposite to the substrate 102, covering the protective layer 118 to form the touch panel 100. Then, the substrate 102 of the touch panel 100 is bonded with the display panel 200 to complete the touch display device 300.

In the embodiment of FIG. 3 and FIG. 4, the substrate 102 may be a substrate of the display panel 200. In this embodiment, the touch sensors of the touch panel 100 are formed on the backside surface of the display panel 200. Therefore, the overall thickness and the cost of the touch display device 300 are reduced due to one substrate is omitted.

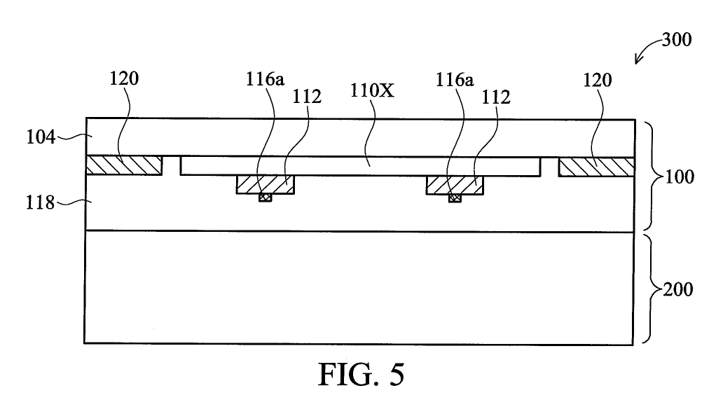

Referring to FIG. 5, a cross section of a touch display device 300 along the cross section line 5-5′ of FIG. 2 according to an embodiment of the invention is shown. The touch display device 300 includes the touch panel 100 disposed on a display panel 200. In an embodiment, the touch panel 100 of FIG. 5 may be an on-glass typed touch panel, which includes a substrate 104 used as a cover lens of the touch panel 100. The substrate 104 may be a glass substrate or a flexible plastic substrate. The peripheral area of the substrate 104 has a light shielding layer 120 formed thereon.

The first conductive patterns 110Y (not shown) and the second conductive patterns 110X are formed on the substrate 104. The isolation structure 112 is formed on the connection portion of the second conductive patterns 110X. The conductive loop 116 (not shown) is formed on the isolation structure 112 and the first conductive patterns 110Y, wherein the vertical conductive bridge structures 116a of the conductive loop 116 are formed on the isolation structure 112 and the horizontal conductive strips 116b (not shown) are formed on the first conductive patterns 110Y. The material of the conductive loop 116 may be a transparent conductive material or a metal material, wherein the metal material is preferred. The vertical conductive bridge structures 116a and the horizontal conductive strips 116b of the conductive loop 116 can be formed at the same time by a deposition, a photolithography and an etching process.

Next, a protective layer 118 is blanketly formed over the substrate 104 to cover the conductive loop 116, the isolation structure 112, the first conductive patterns 110Y and the second conductive patterns 110X to form the touch panel 100. The material of the protective layer 118 may be an organic or an inorganic insulating material. Then, the protective layer 118 of the touch panel 100 is bonded with the display panel 200 to complete the touch display device 300.

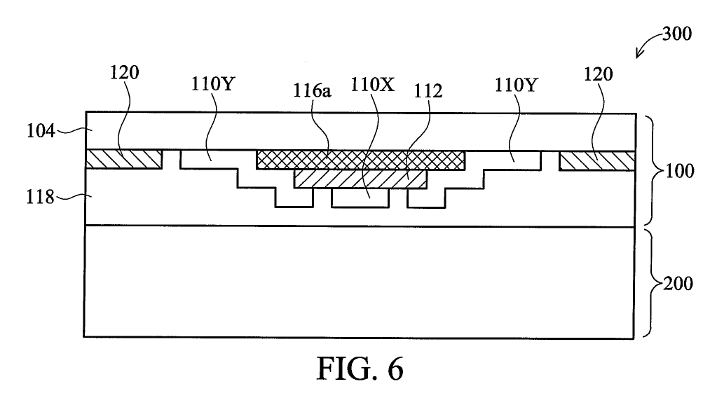

Referring to FIG. 6, a cross section of a touch display device 300 along the cross section line 6-6′ of FIG. 2 according to an embodiment of the invention is shown. The touch display device 300 includes a touch panel 100 disposed on a display panel 200. In an embodiment, the touch panel 100 of FIG. 6 may be an on-glass typed touch panel, which includes a substrate 104 used as a cover lens of the touch panel 100. The substrate 104 may be a glass substrate or a flexible plastic substrate. The peripheral area of the substrate 104 has a light shielding layer 120 formed thereon.

The touch panel 100 of FIG. 6 is different from the touch panel 100 of FIG. 5. First, the conductive loop 116 (not shown, only the conductive bridge structures 116a are shown in FIG. 6) is formed on the substrate 104. Then, the isolation structure 112 is formed on the conductive bridge structures 116a of the conductive loop 116. Next, the first conductive patterns 110Y and the second conductive patterns 110X are formed over the substrate 104, wherein the connection portion of the second conductive patterns 110X is formed on the isolation structure 112 and a portion of the first conductive patterns 110Y is also formed on the isolation structure 112. Meanwhile, a portion of the first conductive patterns 110Y is formed on the conductive loop 116, such that any two adjacent first conductive patterns 110Y are electrically connected with each other through the conductive loop 116. Then, a protective layer 118 is blanketly formed over the substrate 104 to cover the first conductive patterns 110Y and the second conductive patterns 110X to form the touch panel 100. Next, the protective layer 118 of the touch panel 100 is bonded with the display panel 200 to complete the touch display device 300.

In the touch panels of the embodiments of FIG. 3 and FIG. 4, the conductive bridge structure 114 of FIG. 1 is used for an add-on touch panel 100. However, one skilled in the art should appreciate that the conductive loop 116 of FIG. 2 also can be applied to the add-on touch panels 100 of FIG. 3 and FIG. 4. Meanwhile, the conductive bridge structure 114 of FIG. 1 also can be applied to the on-glass typed touch panels 100 of FIG. 5 and FIG. 6.

In summary, the touch display devices of the embodiments are designed to improve the effect of the conductive bridge structures for the touch sensors in the touch panels. A plurality of conductive bridge structures or a conductive loop having a line width not observed by human eyes is utilized for electrically connecting any two adjacent conductive patterns of the touch sensors, such that the light reflection problem of the conductive bridge structures formed from metal is overcome to maintain display quality of the touch display devices. Moreover, the design of the conductive bridge structures of the embodiments can reduce the resistance of the conductive bridge structures and enhance the fabrication yield of the touch panels.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch display device, comprising:
a display panel; and
a touch panel disposed on the display panel, comprising:
a plurality of first conductive patterns arranged along a first direction, wherein the first conductive patterns are separated from each other;
a plurality of second conductive patterns arranged along a second direction perpendicular to the first direction, wherein the second conductive patterns are connected with each other;
an isolation structure disposed between any two adjacent first conductive patterns; and
a plurality of conductive bridge structures disposed on the isolation structure for electrically connecting the any two adjacent first conductive patterns.

2. The touch display device of claim 1, wherein the touch panel further comprises a plurality of conductive strips disposed on the first conductive patterns, and wherein the conductive strips are connected with the conductive bridge structures to form a conductive loop.

3. The touch display device of claim 2, wherein the conductive strips and the conductive bridge structures have a line width of 4 μm to 10 μm.

4. The touch display device of claim 2, wherein the materials of the conductive strips and the conductive bridge structures comprise a metal material.

5. The touch display device of claim 1, wherein the materials of the first conductive patterns and the second conductive patterns comprise a transparent conductive material.

6. The touch display device of claim 1, wherein the isolation structure comprises one or more than one island disposed corresponding to the locations of the conductive bridge structures, the conductive bridge structures are isolated from the second conductive patterns by the isolation structure, and the material of the isolation structure comprises an insulating photosensitive material.

7. The touch display device of claim 1, wherein the first conductive patterns and the second conductive patterns are disposed in the same layer.

8. The touch display device of claim 1, wherein the touch panel further comprises a substrate and a cover lens, the first conductive patterns and the second conductive patterns are disposed on the substrate and the substrate is bonded with the display panel.

9. The touch display device of claim 1, wherein the touch panel further comprises a cover lens and the first conductive patterns and the second conductive patterns are disposed on the cover lens.

10. The touch display device of claim 9, wherein the touch panel further comprises a protective layer to cover the first conductive patterns and the second conductive patterns and the protective layer is bonded with the display panel.
